(19) United States
(12) Patent Application Publication
(10) Pub. No.: US 2006/0212357 A1
(43) Pub. Date: Sep. 21, 2006

(54) Method for integrated point-of-sale and web-based property registration and verification

(76) Inventors: Thomas E. White, Longview, TX (US); John D. Mullikin, Longview, TX (US)

Correspondence Address: Ronald B. Sefrna;Sefrna & Associates, P.O. Box 567, Tyler, TX, 75710, US

(21) Appl. No.: 11/082,442

(22) Filed: Mar. 17, 2005

(51) Int. Cl. G06F 7/00

(52) U.S. Cl. 705/18; 705/16

(57) ABSTRACT

A method for validating ownership of personal property in possession or goods presented for sale, and for automatic activation of product warranty and/or product rebate. At the original point of sale of the property the universal product code and unique serial number of an item of property are acquired using barcode scanners or other input devices, and this data is then linked to the property owner's identification in a national/international owner registration database. Individuals may also enter data and upload property photographs through an internet website. Through a secure website other individuals such as resellers, individual purchasers and law enforcement are able to verify ownership of a presented item of personal property and determine whether a person presenting a registered item of property is the registered owner, whether of not the full identity of the presenter or owner is known, allowing online purchasers and other brokers to ensure that the presented property belong to the seller and providing investigative and validation information to law enforcement agents and property insurers.

### RELATED APPLICATION DATA

This application claims the priority benefit of U.S. Provisional Patent Application Ser. No. 60/664,088, filed Mar. 17, 2004, and titled “Business Model For Integrated Point-Of-Sale And Web-Based Property Registration And Verification”.

### FIELD OF THE INVENTION

The present invention generally relates to internet enabled transaction technology and eBusiness, and in its preferred embodiments more particularly relates to an integrated method of automated capture of product and purchaser identification at point of sale, maintaining such information in secure databases, and providing secure selective access to such information.

### BACKGROUND OF THE INVENTION

When items are lost or stolen, it is difficult to determine ownership unless the owner has etched or branded the item with his or her ID. Unique product serial numbers might identify the item, but this does not identify the owner. It is difficult then to contact the owner or know whether the person in possession of the item is in fact the owner. There is no effective means known in the prior art of knowing whether the item has been stolen unbeknownst to the owner, or if the item has recently been reported stolen or missing. In order to deter theft, improve recovery and protect property owners as well as purchasers, a system is needed that allows private citizens and others to investigate and validate the item in much the same manner that police currently conduct automobile registration searches using Vehicle ID Numbers (VIN). It would be further be useful if this could be done conveniently and securely over the internet, keeping an owner's identity confidential if so desired, with the owner granting specific data privileges to others such as law enforcement or insurance agents, for example.

When an insurer offers property coverage, as part of a homeowners' policy for instance, there is a need to understand what items at what value are covered by the policy in order to accurately access liability risk. A detailed electronic listing of owned goods is needed to provide a basis for claims and to streamline replacement in the event of loss. Keeping these records up to date is time consuming, however, and there is therefore a need for a secure system that automatically adds new items to a policy holders' inventory as they are purchased.

When a new item is purchased, it is time-consuming to fill out and mail warranty and rebate registration forms. The process could be streamlined if all of this paperwork could be eliminated. As the item is purchased, the serial number can be scanned in much the same manner as the Universal Product Code (UPC). All of the warranty and rebate activation can be accomplished automatically using the purchasers ID, which might already be available from a credit card. It would also be valuable to automatically update the purchaser's personal property inventory record with this information.

### PRIOR ART

A method of registering items solely over the internet or utilizing additional interfaces is known. Services for posting lost and found items in a central database through an internet portal are known. Some of these services include interactions with pawn brokers and police to provide law enforcement with a mean of automating pawn shop physical inventory searches.

Reference is made to the following patents and web sites for information on such prior art systems:
U.S. Pat. No. 5,955,952
U.S. Pat. No. 6,449,611
U.S. Patent Application 0020156780
l.e.a.d.s.online
www.businesswatch.ca
http://www.artloss.com/Default.asp
http://www.911find.net/
http://www.internetlostandfound.com/
http://www.boomerangit.com/
http://www.traceit4u.com/pages/welc_page.htm
http://www.pcphonehome.com/
http://www.imfound.com/
http://www.zeasoft.com/hpgn.htm

### SUMMARY OF THE INVENTION

The present invention provides a novel utilization of both web based data entry and Point of Sale (POS) data acquisition technology, together with internet enabled search and validation technology. The invention provides a method of validating ownership of goods in possession or goods presented for sale. This internet enabled method also includes automatic activation of product warranty and/or product rebate application using this data. Barcode scanners or other cash-register input devices at the point of sale are used to read the Universal Product Code (UPC) together with the unique serial number of the purchased item which may also be obtained from a the bar-coded serial number on the exterior of the merchandise packaging. This data is then linked to the purchaser ID in a national/international owner registration database. Individuals may also enter data and upload property photographs through an internet website. Through the use of a secure website and password verification methods, other individuals such as resellers, individual purchasers and law enforcement are able to validate that the individual presenting a registered item is in fact the registered owner, whether of not the full identity of the presenter or owner is known. This allows online purchasers and other brokers to ensure that the presented goods belong to the seller and it provides investigative and validation information to law enforcement agents and property insurers.

### BRIEF DESCRIPTION OF THE DRAWINGS

FIG. 1 is a schematic overview of the system showing the primary interfaces to the central database.

FIG. 2 is a more detailed schematic illustration of the point-of-sale and manufacturer registration interaction.

### DETAILED DESCRIPTION OF THE INVENTION

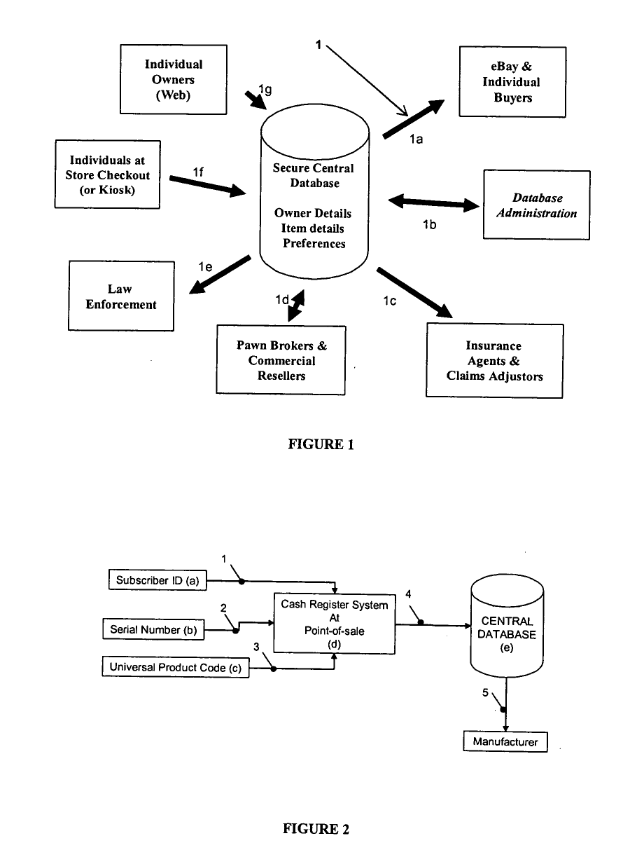

The use of point of sale product information linked with an internet accessible database of personal property inventory is described. As illustrated in FIG. 1, the invention involves a useful integration of property related information. This data is gathered from a variety of interfaces (1). The physical implementation of these interfaces is arbitrary. In the preferred embodiment, they consist of a live internet connection, while in alternate embodiments, they may consist of updates via direct modem connection or by non-real-time updates via email or even mailed electronic media. Of particular significance is the point of sale checkout data (FIG. 2). As in many cash register checkout systems, the UPC code (c) is read from the product label and is input to the point of sale software from the barcode scanner. The UPC identifies the product manufacturer and product model. The invention extends this concept to reading the external unique identifier (Serial Number (b)), preferably using the same UPC barcode reader or radio frequency identifier (RFID). Alternately the data can be obtained by entering the digits and letters through a cash register keyboard. The purchaser's identification is also read into the cash register system, preferably using only the purchaser's credit card number which has been registered and stored in the central database, but alternatively by scanning the purchaser's driver's license or by magnetic or by barcode scanning or manual entry of the purchaser's issued ID number (a) that has been supplied from the central database registration service. This information is then sent via electronic interface to a central database where the purchaser's account is verified and details of purchased item are added to the owner's personal registration inventory list. Knowing the manufacturer from the given UPC, the detailed product, purchase, and owner information will be forwarded to the identified manufacturer for warranty activation and rebate processing, in accordance with the user's predefined preferences. The item registration information is also added to the users' inventory list within said user account in the central database. This updated inventory list is available to insurance providers in the case of loss.

The method employs a means of designating the security preferences for each item of detail associated with the property which is registered with the system. Users use a portal to log into a secure password protected account, preferable via a website. Here the user can check any of several text boxes associated with that item which indicate whether the information should be released to police, insurance agents, pawn brokers etc., thereby reducing the users apprehensiveness by providing selectable privacy. The method also provides overall privacy settings (from “High” to “Low” for example) through the same portal which creates default privacy settings for individual details.

The method employs a means searching the database and anonymously verifying the ownership of specific item in question. Methods of searching databases given search criteria are known, using software query language (SQL) for example. When the item is found, the searcher can ask the presenter of the item for the password which is associated with the registered item. Methods of securely verifying passwords are known such as those employed for logging on to private computer user accounts. If the password cannot be correctly entered, an email and/or automated phone message is sent to the registered owner of the item, notifying said owner of a potential theft. Automated email and phone call methods are known (see http://www.easyivr.com/index.html). A password reminder may also be contained in this message as a means of assisting the owner. According to the user's predefined preferences, a message containing details of the item under search might also be sent to one or more law enforcement or other agencies or email addresses as specified by the user. The method may require that the searcher log on to the system prior to performing the ownership verification. The identity and location of the person performing search or other contact details might then also be included in said automated messages to the registered owner and/or to law enforcement or other agencies.

Operation

Operation of the system includes, but is not limited to, interactions with each of the interfaces (1) of FIG. 1. In the preferred embodiment using the point of sale interface, the user designates an item to be registered to the operator of the point of sale component of the registration system (i.e. the cashier). The cashier scans the product UPC and the bar coded serial number if available on the exterior of the merchandise packaging. The claimed point of sale software adds a charge to the bill for each item so scanned for registration into the database service. Proceeds from this fee may be split between the database service provider and the sales merchant. At the time of payment, the point-of-sale software of this method also associates the user's (i.e. purchaser's) credit card details, the store purchase details (name, location, date), and the purchased item details (serial number and UPC) together for immediate or delayed data transfer to the registration database service. Additional software which automates the claimed method then infers the users identity (i.e. account) from the credit card number which has been listed with the user's account. The items are then added to the existing inventory list for the account. In other embodiments, the product serial number and UPC can be entered by alternate means such as keyboard entry. Alternately, the user's account can be identified by scanning or entering an alternate identification that has been listed with the account, such as a driver's license number or dispensed account ID number, either of which might be available from magnetic or other storage media on the dispensed account card or drivers license.

Once the complete set of data is available and the user's account is known, depending on the user's previously selected preferences, the method employs a known means of secure electronic transfer of the product warranty or rebated processing information to the manufacturer for processing.

The user initiates an account by using an internet portal to access the registration service home page. The user is prompted through a series of menus to enter personal details, which may include one or more credit card numbers to be used to recognize the user when said user is utilizing the point-of-sale mode of data entry. Once an account is established, which may also include electronic payment of a fee for service, the user can then enter data directly through the website as well as through the point of sale. The user is also instructed in the means of uploading one or more digital photographs of the items which can be used to distinguish the item.

When a user wishes to verify a property item, the user accesses the service home page via an internet portal. The user logs in using account name and password and proceeds to the verification page where search criteria such as the make, model and serial number of the item are entered. For items that cannot be identified in this manner, such as artwork or missing persons for example, the user enters more descriptive search criteria after selecting the general categories from the web page menus. A list containing a short description of items matching the criteria is display and the user select on or more items to obtain a more detailed description of the item, which may include one or more photographs. Depending on the registered owner's preference, details about the owner (including photograph) may be listed with the item. If a password has been associated with the item, this can also be entered for verification. In this manner, the user can be confident that the person presenting the item is the registered owner.

Law enforcement and other investigative officials also interact with the system by logging on to a secure website. Password protected accounts will be created for specific individuals or agencies after proper verification of credentials and need-to-know. After log-on, the official will be directed to a set of web page menus whereby an advanced search of the database can be conducted. These menus will allow the official to query the database using any filter criteria that can be constructed using known search methods implemented in Standard Query Language (SQL) for example. The detailed information available will be limited by the security preferences specified by the registered owner of each property item.

Insurance agents will likewise be given a password protected account in order to access the system through an internet portal to the web site. The insurance agent will enter the agency, policy holder name and policy number into the system. If the said policy holder and user of the system has activated his or her account for insurance agent access by entering the associated agency and policy number, then the agent will then have read access to the policy holders inventory list. The list is again subject to the security preferences set by the property owner. The inventory report as well as any available interior/exterior household photographs can then be reviewed by the insurance agent to evaluate risk and flag any unusual items. The documentation is available to be sent electronically to a third party for replacement in the case of a partial or total loss.

The following table provides an outline of the method of the invention and of the functions and interactions performed by software for implementation of the method.

TABLE 1
SOFTWARE ELEMENTS FOR IMPLEMENTATION
OF THE METHOD

| | | | |
|---|---|---|---|
| 1 | General | | |
| 2 | User Interface | | |
| 2.1 | Owner Interface | The system shall provide a | |
| | | segregated interface for users to | |
| | | register owned items. | |
| 2.1.1 | Owner Details | The system shall include an owner | Information such as name, |
| | | entry page to include capture of | number address etc. |
| | | normal relevant owner details. Name | |
| | | and Phone or Email shall be | |
| | | mandatory others optional | |
| 2.1.2 | Agent | Owner input page shall allow for | |
| | designation | specification of insurance agent and | |
| | | policy number. | |
| 2.1.3 | Printable | The system shall be capable of | |
| | Inventory Report | producing professional printable | |
| | | reports listing the owners inventory of | |
| | | goods. | |
| 2.1.4 | Creation and | Original entry dates revision history | Revision history will establish |
| | revision history | shall be stored for each entered item. | plausible ownership dates. |
| 2.1.5 | Owner | The system shall be capable storing a | |
| | Photograph | 320 × 240 photograph of the owner. | |
| 2.1.6 | Item Data Entry | | |
| 2.1.6.1 | Item Details | The system shall enable entry and | |
| | | storage make, model, SN, name, | |
| | | description of any number of items | |
| | | per owner. | |
| 2.1.6.2 | Fixed | The system shall facilitate uniform | |
| | Make/Model | data entry through the use of fixed | |
| | | make/model choices for each item. | |
| 2.1.6.3 | Categories | The system shall provide partitioning | |
| | | of inventory items through the use of | |
| | | fixed categories for each item. | |
| 2.1.6.4 | Item Photograph | The system shall be capable of | |
| | | storing up to 640 × 480 digital | |
| | | photograph of the item. | |
| 2.2 | Buyer Interface | The system shall provide a | |
| | | segregated interface to allow potential | |
| | | purchasers of registered items to | |
| | | verify the status of the item. | |
| 2.2.1 | Payment options | The system shall support credit card | |
| | | payment for TBD day access, monthly | |
| | | access and annual access | |
| 2.2.2 | Initiate searches | The system shall allow buyers to | |
| | | initiate and search for registered items | |
| | | in accordance with the service | |
| | | purchased | |
| 2.2.3 | View Hot item | When a searched item has been | |
| | alert | reported stolen by the owner, an alert | |
| | | message shall be displayed which | |
| | | identifies the item as reported stolen | |
| | | and instructs the user to refuse the | |
| | | item and report details of the | |
| | | possessor. | |
| 2.2.4 | View reward on | A reward may be offered by the owner | |
| | Hot Item | for recovery of a reported item, with | |
| | | details available to the user. | |
| 2.3 | Law | The system shall provide a | |
| | Enforcement | segregated interface for law | |
| | | enforcement personnel to investigate | |
| | | registered item information and | |
| | | contact owners of recovered items. | |
| 2.3.1 | Data Access | Owner and registered item detailed | |
| | levels | data shall be made available to law | |
| | | enforcement agents in accordance | |
| | | with the registered owner's | |
| | | designation. | |
| 2.3.2 | initiate searches | The system shall allow authorized law | |
| | | enforcement officials to initiate and | |
| | | search for registered items. | |
| 2.3.3 | Perform | Authorized law enforcement officials | Subject to the owner |
| | Advanced | shall have the ability to perform | designated privacy |
| | search | search queries based on any | specification |
| | | combinations of owner detail and | |
| | | registered item field. | |
| 2.3.4 | Printable report | The system shall produce | |
| | | professional, printable reports based | |
| | | on the queries | |
| 2.4 | Insurance Agent | The system shall provide a | |
| | | segregated interface for designated | |
| | | insurance providers to track and | |
| | | document insured items. | |
| 2.4.1 | Agent Access | Owner designated agent shall have | |
| | Level | access to all owner details and owner | |
| | | inventory list. | |
| 2.4.2 | Generate | Owner designated agent shall have | |
| | inventory report | the ability to produce both an | |
| | | electronic and printable detailed | |
| | | inventory report, to include purchase | |
| | | price and estimated value for all items | |
| | | registered by the owner. | |
| 3 | Import/Export | | |
| 3.1 | Import Quicken | The system shall allow owners to | |
| | Home Inventory | select quicken QIF file form local disk | |
| | | and import relevant inventory. | |
| 3.2 | Import MS | The system shall allow owners to | (Need to verify the MS Money |
| | Money Home | select an MS Money file form local | supports home inventory file. |
| | Inventory | disk and import relevant inventory. | |
| 3.3 | Vendor Data | The application shall support transfer | Point of sale information |
| | Transfer | of registration data from a variety of | collected by a multiple |
| | | external data sources with varying | vendors (e.g. Snap-on, Home |
| | | native formants. | Depot) is to be imported to |
| | | | the database. The application |
| | | | must support customization |
| | | | based on the vendor's native |
| | | | system. Transfer of existing |
| | | | databases must also be |
| | | | supported. |
| 4 | Search | | |
| | Capability | | |
| 4.1 | Search by Make, | The system shall employ a fixed | |
| | Model, SN | selection set of such as pull down | |
| | | menus for the entry of product make | |
| | | and model | |
| 4.2 | Search by | The system shall be capable off | |
| | keywords | searching item description and other | |
| | | the item entry text. | |
| 4.3 | Search Time | The system shall take no longer that 3 | |
| | | seconds to perform any search given | |
| | | a database size of TBD entries. | |
| 4.4 | Find Similar | The item search function shall return | |
| | | a list of items that are similar to that | |
| | | entered. | |
| 4.4.1 | Same | find items with same serial number, | |
| | make/Model | different make and/or model. | |
| 4.4.2 | 2 digits of SN | find items with up to two digits | |
| | | difference in Serial number (as a | |
| | | minimum requirement). | |
| 4.4.3 | Missing Digits | Find items with 1 missing digit (as a | |
| | | minimum requirement). | |
| 5 | Security | | |
| 5.1 | Log-on Accounts | Owners, insurance agents and law | |
| | | enforcement agents shall be granted | |
| | | access the system through the use of | |
| | | secure login and password. | |
| 5.2 | Issued | Passwords shall be issued by email to | |
| | Passwords | verified insurance and law | |
| | | enforcement agents | |
| 5.3 | Secure | The website shall implement a Secure | Confidential transactions |
| | Connection | Socket Link for all confidential | include login information, |
| | | transactions. | owner detail entry/edit, credit |
| | | | card entry/edit and inventory |
| | | | entry/edit |
| 5.4 | Secure Data | All stored data shall be protected from | |
| | | unauthorized access | |
| 5.5 | Privacy Options | Owner shall have the option of | |
| | | specifying reliability to Buyer, Law | |
| | | Enforcement and Insurance agent for | |
| | | each item of owner details. | |
| 6 | Administration | | |
| 6.1 | Access Levels | The system shall implement user level | TBD levels for access to |
| | | access to the secure database | specific classes of data |
| | | system. | |
| 6.2 | Update | The system shall allow administrators | |
| | Make/Model list | to update the approved list of Make | |
| | | and Model appearing in the owner | |
| | | item entry pull-down menu. | |
| 6.3 | Automated | Full system backups shall be | |
| | backups | performed at TBD intervals (daily). | |
| | | Incremental backups shall be | |
| | | performed at TBD intervals (hourly). | |
| 6.4 | Redundancy/ | Backups shall be performed to at | |
| | Physical | least two separate storage media | |
| | protection | which are separated by a physical | |
| | | distance of at least 50 miles. | |
| 7 | Miscellaneous | | |
| 7.1 | Paste rows from | The inventory table shall be capable | |
| | clipboard | of accepting paste rows and columns | |
| | | from the OS clipboard | |
| 7.2 | Email | The system shall notify owners by | No searcher information is |
| | Notification | Email when items in inventory have | supplied. Searcher is first |
| | | been searched. | required to answer yes to |
| | | | query Has someone |
| | | | presented this item to you? |

1. A method of verifying ownership of personal property, comprising the steps of
acquiring unique identifying information associated with an item of personal property at the point of original sale of said item to an original owner, and acquiring unique information establishing the identity of said original owner at the point of original sale of said item to said original owner;
storing said unique identifying information associated with said item of personal property and said unique information establishing the identify of said owner in a database to register said item and said owner, and within said database relating said unique identifying information associated with said item of personal property with the identity of said original owner and with unique identity verification information provided by said original owner;
providing access to said database by a person desiring to verify ownership of an item of personal property claimed to be owned by a presenter of said item of personal property to said person;
conducting a search of said database by said person based upon said unique identifying information associated with said item of personal property to determine whether said item of personal property is registered in said database and to retrieve said unique identity verification information for said owner if said item of personal property is registered so as to enable said person to verify whether said presenter is said owner.

2. The method of claim 1, wherein said unique identifying information associated with said item of personal property includes a universal product code and the serial number of said item.

3. The method of claim 2, wherein said unique identifying information associated with said item of personal property is in the form of a machine readable code, and wherein said unique identifying information is acquired by scanning said code during the sale of said item to said original owner.

4. The method of claim 3, wherein said machine readable code is a bar code, and wherein said code is scanned using a bar code reader.

5. The method of claim 3, wherein said machine readable code is stored in a radio frequency identification tag, and wherein said code is scanned by transmitting said code to a radio frequency identification code receiver.

6. The method of claim 2, wherein said unique identifying information associated with said item of personal property is acquired by manual entry of said information during the sale of said item to said original owner.

7. The method of claim 2, wherein said unique identifying information associated with said item of personal property and said unique information establishing the identity of said original owner is acquired at a free-standing kiosk following the sale of said item to said original owner.

8. The method of claim 1, wherein said database is stored on a computer system, the method further comprising the step of transmitting said information to said computer system on which said database is stored, between the step of acquiring said information and the step of storing said information in said database.

9. The method of claim 1, wherein said database is stored on a computer system, and wherein said access to said database is provided via a computer connection.

10. The method of claim 1, wherein said person desiring to verify ownership of said item of personal property is included within a category of persons including prospective purchasers of said item, pawn brokers, operators of property resale websites, law enforcement officials, insurance agents, and insurance claims adjustors.

11. The method of claim 1, wherein said original owner has a driver's license, and wherein said unique information establishing the identity of said original owner is acquired by scanning said drivers license.

12. The method of claim 1, wherein said original owner has a personal identification card, and wherein said unique information establishing the identity of said original owner is acquired by scanning said personal identification card.

13. The method of claim 1, wherein said original owner has a credit card, and wherein said unique information establishing the identify of said original owner is acquired by scanning said credit card.

14. A method of verifying ownership of an item of personal property, comprising the steps of
acquiring unique identifying information associated with the item of personal property from the owner of said item, and acquiring unique information establishing the identity of said owner;
transmitting said unique identifying information associated with said item of personal property and said unique information establishing the identify of said owner to a computer system;
storing said unique identifying information associated with said item of personal property and said unique information establishing the identify of said owner in a database on said computer system to register said item and said owner, and within said database relating said unique identifying information associated with said item of personal property with the identity of said original owner and with unique identity verification information provided by said original owner;
providing access to said database by a person desiring to determine ownership of an item of personal property;
conducting a search of said database by said person based upon said unique identifying information associated with said item of personal property to determine whether said item of personal property is registered in said database and to retrieve a portion of said unique identity verification information for said owner authorized for retrieval by said owner.

15. The method of claim 14, wherein said unique identifying information associated with said item of personal property and said unique information establishing the identity of said owner is acquired at the point of sale of said item to said owner as a part of the sales transaction.

16. The method of claim 14, wherein said unique identifying information associated with said item of personal property and said unique information establishing the identity of said owner is acquired at the time of sale of said item to said owner separate from the sales transaction.

17. The method of claim 14, wherein said unique identifying information associated with said item of personal property and said unique information establishing the identity of said owner is acquired subsequent to the purchase of said item by entry of said information by said owner through an internet website.

18. The method of claim 14, further comprising the step of automatically transmitting said unique identifying information associated with said item of personal property and information regarding the identify of said owner to the manufacturer of said item of personal property for purposes of registering warranty and claiming any available rebates.

19. The method of claim 14, further comprising the step of establishing an account by said owner prior to storing said information in said database, during which step said owner is able to establish limitations regarding the portions of said information establishing the identify of said owner authorized for release to persons other than said owner.

20. A method of associating information regarding items of personal property and information identifying the owner of such personal property, and providing such information to selected persons, comprising the steps of
acquiring unique identifying information associated with an item of personal property at the point of sale of said item to an owner, acquiring owner identify information establishing the identity of said owner, and acquiring unique owner identification information from said owner;
transmitting said unique identifying information associated with said item of personal property to a computer system;
transmitting said owner information and said owner identification to said computer system;
storing said unique identifying information associated with said item of personal property and said owner information in a database on said computer system to register said item and said owner, and within said database relating said unique identifying information associated with said item of personal property with the identity of said owner and with unique identification information provided by said owner;
providing access to said database by a person desiring to determine ownership of personal property by said owner;
conducting a search of said database based upon input information by said person selected from a group of information including said unique identifying information associated with said personal property and said owner identity information, to retrieve information from said database stored in said database as related to said input information; and
displaying to said person information retrieved from said database by said search.
